(19) United States
(12) Patent Application Publication
(10) Pub. No.: US 2018/0315108 A1
(43) Pub. Date: Nov. 1, 2018

(54) OMNI-CHANNEL MANAGEMENT APPARATUS AND METHOD FOR THE SAME

(71) Applicant: ELECTRONICS AND TELECOMMUNICATIONS RESEARCH INSTITUTE, Daejeon (KR)

(72) Inventors: Weon Geun OH, Daejeon (KR); Jong Gook KO, Daejeon (KR); Da Un JUNG, Goyang-si (KR); Seung Jae LEE, Daejeon (KR); Hyung Kwan SON, Daejeon (KR); Keun Dong LEE, Daejeon (KR)

(21) Appl. No.: 15/959,454

(22) Filed: Apr. 23, 2018

(30) Foreign Application Priority Data
Apr. 26, 2017 (KR) 10-2017-0053489

(51) Int. Cl. G06Q 30/06; G06F 17/30; G06K 7/14; G06K 9/00

(52) U.S. Cl. CPC G06Q 30/0623; G06F 17/30026; G06Q 30/0603; G06K 9/00; G06K 2209/25; G06K 7/1417

(57) ABSTRACT

An omni-channel management method includes receiving a distribution channel information and a product purchase information from each of a plurality of distribution channels, and integrating the received distribution channel information and the product purchase information; applying an image identification technology and a voice identification technology to retrieve and integrate information related to a product; receiving and integrating product information from a manufacturer, a seller, or a web site; verifying consistency of the integrated product information by checking whether detailed information included in the integrated product information is related to a same product; and providing the consistency-secured product information to a consumer and a plurality of distribution channels.

### CROSS-REFERENCE TO RELATED APPLICATION

This application claims priority to Korean Patent Application No. 10-2017-0053489, filed on Apr. 26, 2017 in the Korean Intellectual Property Office (KIPO), the entire content of which is hereby incorporated by reference.

### BACKGROUND

### 1. Technical Field

The present disclosure relates to an omni-channel management apparatus and a method for the same, and more specifically, to an omni-channel management apparatus based on product information using multimedia (e.g., video and voice) identification technologies, and an operation method of the same.

### 2. Description of Related Art

The development of the Internet and the emergence of smart devices have changed dramatically existing shopping structures and shopping methods, and are changing them to online purchases through the Internet and smart devices. The way of shopping is changing from offline stores into a form of ‘omni-channel’ to maximize customer experience management by integrating a plurality of channels such as Internet and mobile.

FIG. 1 is a diagram for explaining an omni-channel service according to the prior art.

Referring to FIG. 1, an omni-channel service is provided so that consumers can search for and purchase products using various channels such as online, offline, and mobile. The omni-channel provides consumers with a shopping environment that combines the characteristics of respective sales channels and makes them feel like they are using the same store on any sales channel. Especially, it provides a shopping environment from a customer-centered viewpoint and continuously connects the shopping environment with the customers. This can eliminate channel boundaries, provide unified experiences for the customers, and enable integrated customer managements and complementary revenue/profit managements.

Since the existing omni-channel service is focused only on maximizing the customer's purchase experiences, there are problems in difficulty to obtain product information (price, refund policy, delivery information, locations of supply shops, etc.) and lack of consistency in the product information. Also, the existing omni-channel service has a problem that it takes a long time until a final purchase decision is made, a satisfaction degree of a purchased product is low, and a refund rate is high. Also, the existing omni-channel service lacks consistency of product information such as expiration dates of products, inventory management, and the like in a distribution process, so that it is not possible to provide complete and accurate latest product information to distributors. As a result, it is impossible to provide a service for inducing consumers to purchase products.

### SUMMARY

Accordingly, embodiments of the present disclosure provide an omni-channel management apparatus and a method for the same, which can provide customers and distributors with consistent product information usable for product purchases and product managements.

Accordingly, embodiments of the present disclosure also provide an omni-channel management apparatus and a method for the same, which can realize an omni-channel service centered on consistent product information obtained through integration of distribution channels, product information, and product identification schemes.

In order to achieve the objective of the present disclosure, an omni-channel management method may comprise receiving a distribution channel information and a product purchase information from each of a plurality of distribution channels, and integrating the received distribution channel information and the product purchase information; applying an image identification technology and a voice identification technology to retrieve and integrate information related to a product; receiving and integrating product information from a manufacturer, a seller, or a web site; verifying consistency of the integrated product information by checking whether detailed information included in the integrated product information is related to a same product; and providing the consistency-secured product information to a consumer and a plurality of distribution channels.

The information related to the product may be retrieved by identifying a barcode, a number, or a logo from an image of the product through the image identification technology.

The information related to the product may be retrieved by identifying a product name, a model number, a production site, or a delivery site through the voice identification technology.

The product information may be generated in a form of metadata, and include at least one of a product name, an electronic product code (EPC), an EPC bar code, a bar code image, a bar code image descriptor, a product image, a product image descriptor, a product 3D image, a 3D image descriptor, a logo of the product or a company manufacturing the product, a logo image descriptor, a voice signal representing the product name, a voice signal descriptor, and information on a website providing information related to the product.

The information on a website may include a directly-related website information including an Internet address of a home page of a company or store that produces, manages, and distributes the product or an Internet address of a home page providing information on the product, and a indirectly-related website information including an Internet address of a home page providing information related to the product, or the website address of the vendor or store related to the product.

The product information may be received and integrated through a logo identification scheme, a product image identification scheme, a bar code identification scheme, a voice identification scheme, and an EPC identification scheme, and it may be verified whether the integrated product information is related to a same product.

In order to achieve the objective of the present disclosure, an omni-channel management apparatus may comprise a network interface connected to a plurality of distribution channels and a terminal of a consumer, which transfers a product purchase request and a production information request from the terminal; a distribution channel integration unit receiving and integrating a distribution channel information and a product purchase information from each of the plurality of distribution channels; a product identification integration unit retrieving information related to a product by applying an image identification technology and a voice identification technology, and integrating and outputting the retrieved information; a product information integration unit receiving and integrating product information from a manufacturer, a seller, or a website; and a product information verification unit verifying consistency of the integrated product information by checking whether detailed information included in the integrated product information is related to a same product, and outputting the consistency-secured product information.

The network interface may connect the plurality of distribution channels with the distribution channel integration unit, the product identification integration unit, the product information integration unit, and the product information verification unit, and provide the product purchase request and the production information request from the consumer to the plurality of distribution channels.

The plurality of distribution channels may include a server serving an online shopping mall, a Position of Sale (POS) apparatus disposed in an offline store, and a server serving a mobile shopping mall accessible through a mobile terminal, and the consistency-secured product information may be provided to the plurality of distribution channels.

The product identification integration unit may retrieve the information related to the product by identifying a barcode, a number, or a logo from an image of the product through the image identification technology.

The product identification integration unit may retrieve the information related to the product by identifying a product name, a model number, a production site, or a delivery site through the voice identification technology.

The product information integration unit may generate the product information in a form of metadata, and the production information may include at least one of a product name, an electronic product code (EPC), an EPC bar code, a bar code image, a bar code image descriptor, a product image, a product image descriptor, a product 3D image, a 3D image descriptor, a logo of the product or a company manufacturing the product, a logo image descriptor, a voice signal representing the product name, a voice signal descriptor, and information on a website providing information related to the product.

The product information verification unit may integrate product information collected through a logo identification scheme, a product image identification scheme, a bar code identification scheme, a voice identification scheme, and an EPC identification scheme, and verify whether the integrated product information is related to a same product.

Using the apparatus and method for managing an omni-channel according to embodiments of the present disclosure, it is made possible to provide consistent product information useful for product purchase and managements to consumers and distributors. In addition, by integrating distribution channels, product information, and product identification schemes, the omni-channel centered on consistent product information can be implemented.

Using the apparatus and method for managing an omni-channel according to embodiments of the present disclosure, the consumers can check information on the distribution channels and the product information without restriction of time and space by using offline stores, internet shopping malls, digital signage, and mobile terminals. Also, it is made possible to further confirm details of the product (price, refund policy, delivery information, location of supply shop, etc.) based on the product information provided to the consumer.

Using the apparatus and method for managing an omni-channel according to embodiments of the present disclosure, in the distribution channel, management of the distribution and manufacture of the product can be integrated and operated based on the received product information. Also, this can enhance the automation of product distribution, production and management, reducing management and operating costs, and reducing time spent on business processes.

### BRIEF DESCRIPTION OF DRAWINGS

Embodiments of the present disclosure will become more apparent by describing in detail embodiments of the present disclosure with reference to the accompanying drawings, in which:

FIG. 1 is a diagram for explaining an omni-channel service according to the prior art;

FIG. 2 is a diagram illustrating an omni-channel management apparatus according to an embodiment of the present disclosure;

FIG. 3 is a diagram illustrating the processor shown in FIG. 2;

FIG. 4 is a diagram illustrating an omni-channel structure centered on product information;

FIG. 5 is a diagram illustrating a method of providing product information by integrating product identification schemes;

FIG. 6 is a diagram illustrating a structure of metadata in which product information is integrated;

FIG. 7 is a diagram illustrating product information using an electronic product code (EPC) bar code and a unique serial number;

FIG. 8 is a diagram illustrating product information provided using a three-dimensional image of the product;

FIG. 9 is a diagram illustrating types of product information provided by identifying a product through the omni-channel management apparatus; and

FIG. 10 is a diagram illustrating an omni-channel management method according to an embodiment of the present disclosure.

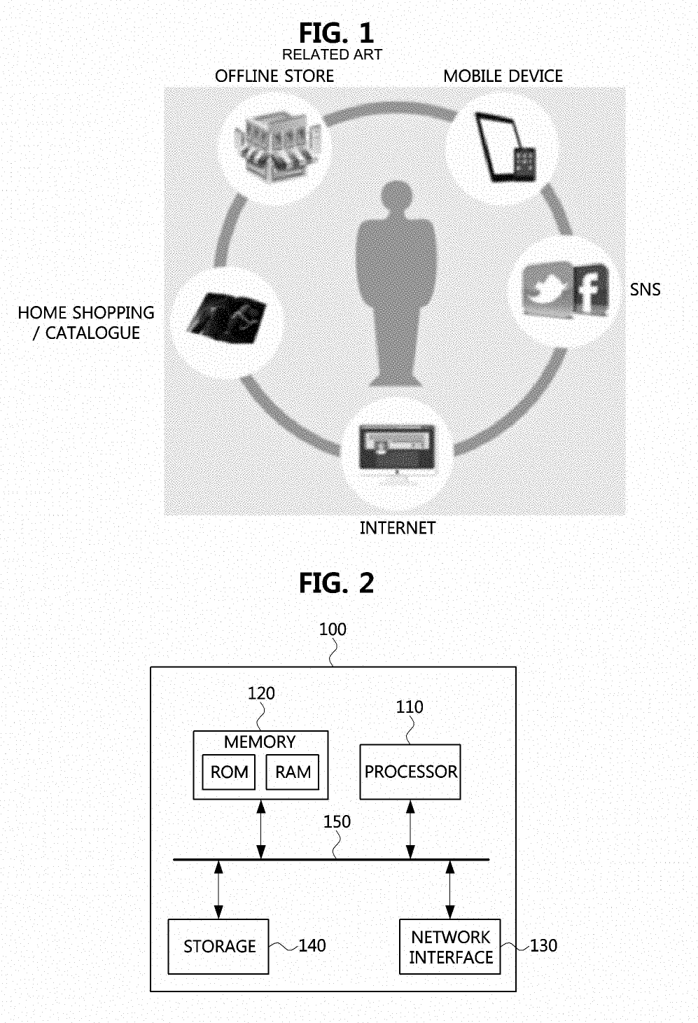

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate a thorough understanding of the present disclosure, the same reference numerals are used for the same constituent elements in the drawings and redundant explanations for the same constituent elements are omitted.

The apparatus and method for managing an omni-channel according to embodiments of the present disclosure may integrate distribution channels, product information, and product identification schemes to implement an omni-channel service centered on consistent product information. Also, the apparatus and method can provide the consistent product information to consumers and distributors.

FIG. 2 is a diagram illustrating an omni-channel management apparatus according to an embodiment of the present disclosure.

Referring to FIG. 2, an omni-channel management apparatus 100 according to an embodiment of the present disclosure may implement an omni-channel centered on product information. The apparatus 100 may integrate distribution channels, product information, and product identification schemes so as to provide consistency-secured product information. For this, the omni-channel management apparatus 100 according to an embodiment of the present disclosure may comprise a processor 110, a memory 120, a network interface 130 connected to a network to perform communications, a storage 140, and a bus 150. The processor 110, the memory 120, the network interface 130, and the storage 140 of the omni-channel management apparatus 100 may be connected to the bus 150 and communicate with each other.

The processor 110 may execute a program code stored in at least one of the memory 120 and the storage device 140. The processor 110 may refer to a central processing unit (CPU), a graphics processing unit (GPU), or a dedicated processor on which methods in accordance with embodiments of the present disclosure are performed. Each of the memory 120 and the storage 140 may be configured with at least one of a volatile storage medium and a non-volatile storage medium. For example, the memory 120 may comprise at least one of a read only memory (ROM) and a random access memory (RAM). Also, the storage 140 may store product information whose consistency has been verified, which will be described later.

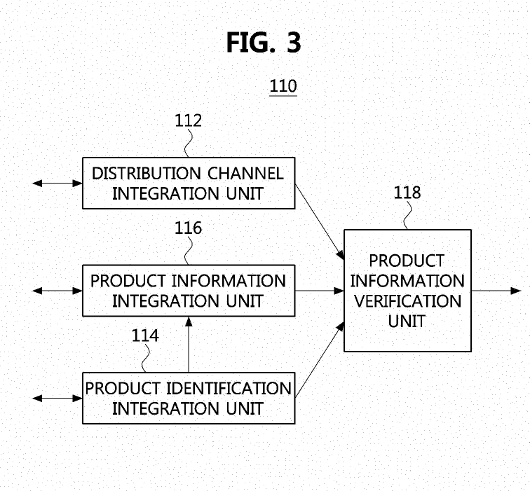

FIG. 3 is a diagram illustrating the processor shown in FIG. 2.

Referring to FIG. 3, the processor 110 includes a distribution channel integration unit 112, a product identification integration unit 114, a product information integration unit 116, and a product information verification unit 118. The distribution channel integration unit 112, the product identification integration unit 114, the product information integration unit 116, and the product information verification unit 118 may be connected to a plurality of distribution channels (sales channels) through the network interface 130 to transmit and receive data. The distribution channel integration unit 112, the product identification integration unit 114, and the product information integration unit 116 of the processor 110 may receive product information and purchase orders from a plurality of distribution channels (sales channels).

Also, the distribution channel integration unit 112, the product identification integration unit 114, the product information integration unit 116, and the product information verification unit 118 may be connected to a terminal of a consumer (buyer) through the network interface 130, receive a product purchase request and a product information request from the consumer, and transmit the requested product information to the terminal of the consumer. Also, the product information request and the product purchase request from the consumer may be provided to a plurality of distribution channels.

Here, the plurality of distribution channels may logically mean different types of buyer contact channels. Also, the plurality of distribution channels may physically mean computer devices used for the buyer contact in the respective distribution channels. For example, servers serving online shopping malls, position of sale (POS) devices located at offline stores, and mobile shopping mall servers accessible through mobile terminals may be applied as the plurality of distribution channels.

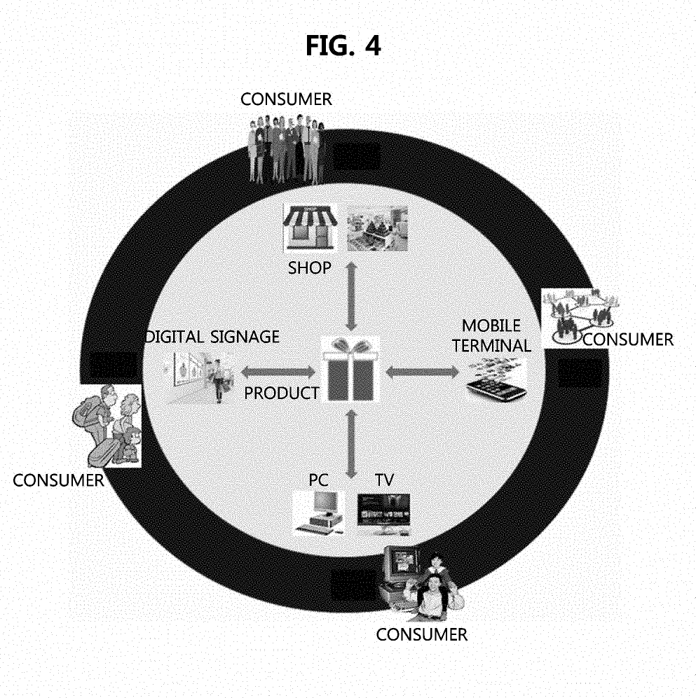

FIG. 4 is a diagram illustrating an omni-channel structure centered on product information.

Referring to FIG. 4, in order to implement an omni-channel centered on product information, a plurality of distribution channels may be managed through convergence of the distribution channels. The distribution channel integration unit 112 may receive distribution channel information and product purchase information of each distribution channel from the plurality of distribution channels such as offline stores, Internet shopping malls, digital signage, and mobile terminals, and provide the product information verification unit 118 with the received distribution channel information and product purchase information of each distribution channel.

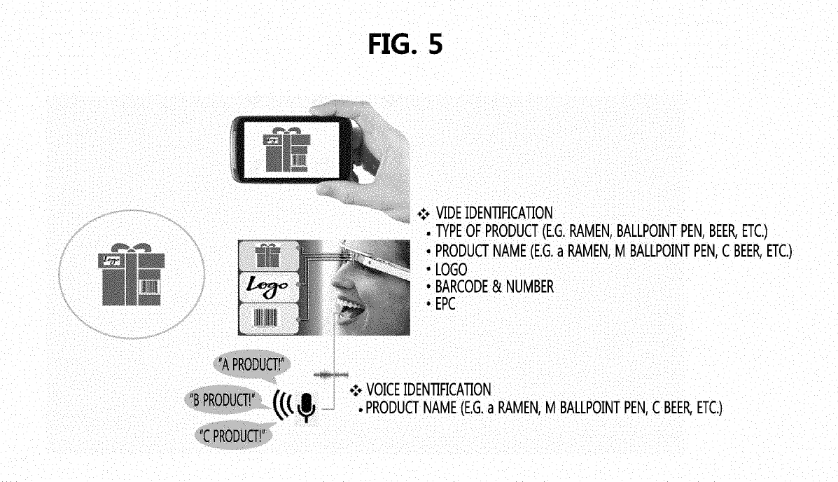

FIG. 5 is a diagram illustrating a method of providing product information by integrating product identification schemes.

Referring to FIG. 5, a technology for identifying product information using a smart terminal is largely classified into a scheme of using images and a scheme of using voices, and the respective identification schemes may be integrated into a signal platform so that product related information can be retrieved through any type of identification information. The product identification integration unit 114 may retrieve product information by applying the image identification technology and the voice identification technology, integrate the retrieved product information, and provide the integrated product information to the product information verification unit 118.

Specifically, the product identification integration unit 114 may identify an image of the product or a barcode, a number, a logo, or the like attached to the product by applying the image identification technology to retrieve the product information, and transmit the retrieved product information to the product information verification unit 118. Also, the product identification integration unit 114 may identify the product information by applying the voice identification technology. For example, the product information such as a product name, a model number, a production site, and a delivery address may be retrieved by voices.

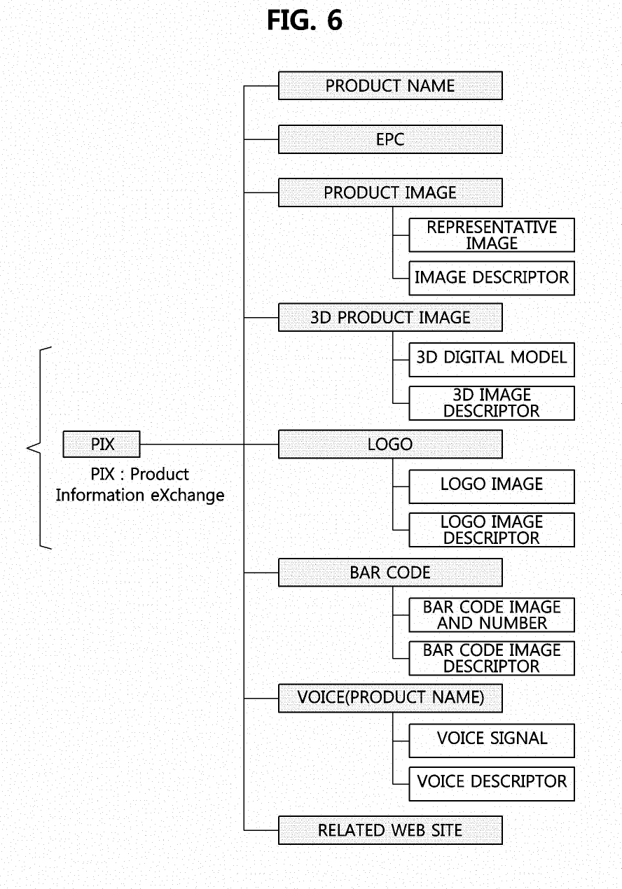

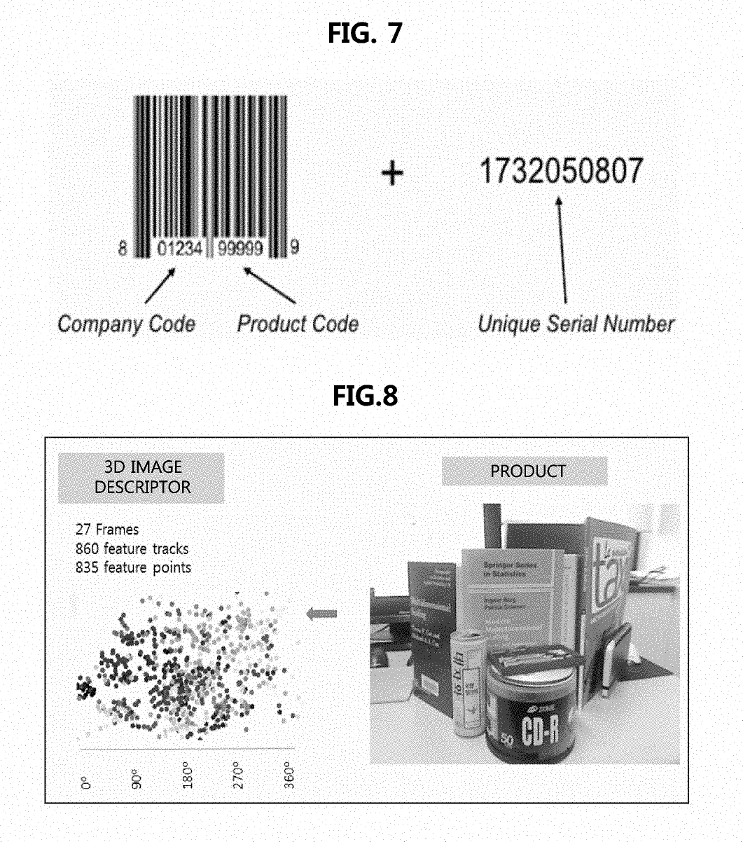

FIG. 6 is a diagram illustrating a structure of metadata in which product information is integrated, and FIG. 7 is a diagram illustrating product information using an electronic product code (EPC) bar code and a unique serial number.

Referring to FIG. 6, the product information integration unit 116 may receive product information from a manufacturer, a seller, and a product information database (e.g., web site) through the network interface 130 to provide the product information according to a product information request from a consumer or a distribution channel. Also, the product information integration unit 116 may receive the product information from the product identification integration unit 114. Then, the product information integration unit 116 may integrate the received product information and transmit the integrated product information to the product information verification unit 118 so that the product information is provided to the consumer or the distribution channel. The product information integration unit 116 may generate the product information in a form of metadata (e.g., Product Information eXchange (PIX)) as shown in FIG. 6.

Here, the product information integration unit 116 may include a product name such as (A ramen, B udon, C cosmetics, or the like) into the product information. Also, the product information integration unit 116 may include an EPC code or an EPC barcode shown in FIG. 7 as a code for identifying the product into the product information. Here, the EPC code is composed of a header, an EPC manager, an object class, and a serial number. Such an EPC code may be used to prevent counterfeit goods, and to perform expiration management, inventory management, and product tracking with ease.

Also, the product information integration unit 116 may include a product image representing an external appearance of the product into the product information. Specifically, a product representative image, for example, a front image of the product, which best represents the product among images representing the appearance of the product, may be included into the product information. In addition, the product information integration unit 116 may include an image descriptor that describes the characteristics of the product representative image (intrinsic properties distinguishing the representative image from other images as features or characteristics of the representative image) into the product information.

FIG. 8 is a diagram illustrating product information provided using a three-dimensional image of the product.

Referring to FIG. 8, the product information integration unit 116 may include a 3D image of the product into the product information. The 3D image generated by 3D scanning or 3D modeling of the external appearance of the product may be included in the product information so that the appearance of the product can be confirmed in any direction of 360 degrees. Also, the product information integration unit 116 may include a 3D image descriptor, which describes the characteristics of the 3D image of the product (intrinsic properties distinguishing the 3D image from other images as features or characteristics of the 3D image), into the product information. At this time, a 3D image descriptor corresponding to a 3D image per viewpoint may be generated.

Also, the product information integration unit 116 may include a visual design (e.g., a logo) which is applied to the product or a commercial organization (e.g., an organization such as a company) related to the product into the product information. Specifically, the product information integration unit 116 may include a logo image, which is a visual design image representing the product or the company, in the product information. In addition, the product information integration unit 116 may include a logo image descriptor in the product information, which describes the characteristics of the logo image (intrinsic properties distinguishing it from other images as features or characteristics of the logo image).

Also, the product information integration unit 116 may include a bar code image into the product information. In addition, the product information integration unit 116 may include a bar code image descriptor in the product information, which describes the characteristics of the bar code image (intrinsic properties distinguishing it from other images as features or characteristics of the bar code image).

Also, the product information integration unit 116 may include a digital voice signal generated to represent the product name by voice into the product information. In addition, the product information integration unit 116 may include a voice signal descriptor that describes the acoustic feature of the voice signal in the product information.

Also, the product information integration unit 116 may include information on related web sites providing information related to the product, into the product information. Here, the related website information may be divided into directly-related web site information and indirectly-related web site information.

The directly-related website information may include an Internet address of a home page of a company or store that produces, manages, and distributes the product or an Internet address of a home page providing information on the product. The indirectly-related website information may include an Internet address of a home page providing information related to the product, or the website address of the vendor or store related to the product.

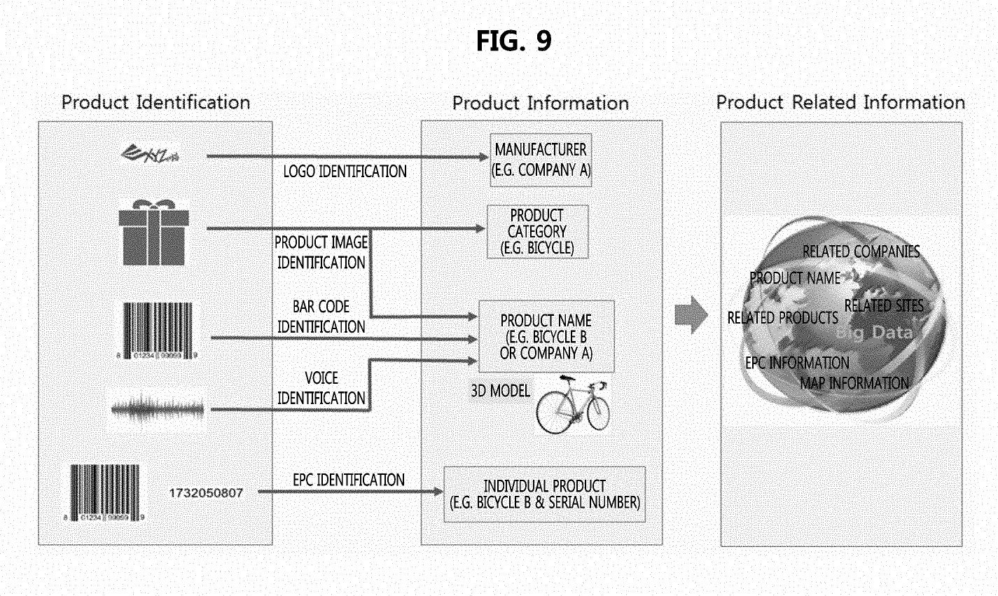

FIG. 9 is a diagram illustrating types of product information provided by identifying a product through the omni-channel management apparatus.

Referring to FIG. 9, the product information verification unit 118 may integrate the product information collected through a logo identification scheme, a product image identification scheme, a bar code identification scheme, a voice identification scheme, and an EPC identification scheme, and verify whether the integrated details are correct for the same product. That is, it is verified whether the plurality of detailed information is information on the same product so that the product information is to be consistent. Then, the product information that has been verified is provided to the consumer and the distribution channel.

Specifically, the product information verification unit 118 may integrate the distribution channel information received from the distribution channel integration unit 112 and the product information received from the product information integration unit 116 and the product identification integration unit 114. After verifying the consistency of the integrated product information, the product information verification unit provides the product information whose consistency has been verified to the consumer. At this time, the product information provided by the product information verification unit 118 may include at least one of the logo of the company that manufactured the product, the image of the product, the barcode of the product, the voice information of the product, and the EPC (product name, management number) of the product. The consumer can check information on the distribution channels and the product information without restriction of time and space by using offline stores, internet shopping malls, digital signage, and mobile terminal. Also, it is possible to further confirm details of the product (price, refund policy, delivery information, locations of supply shops, etc.) based on the product information provided to the consumer.

Also, the product information verification unit 118 may integrate the product information received from the product information integration unit 116 and the product identification integration unit 114. After verifying the consistency of the integrated product information, the product information that has been verified with consistency may be provided to a plurality of distribution channels. At this time, the product information provided by the product information verification unit 118 may include at least one of the logo of the company that manufactured the product, the image of the product, the barcode of the product, the voice information of the product, and the EPC (product name, management number) of the product. In the distribution channel, management of the distribution and manufacture of the product can be integrated and operated based on the received product information. This can enhance the automation of product distribution, production and management, reducing management and operating costs, and reducing time spent on business processes.

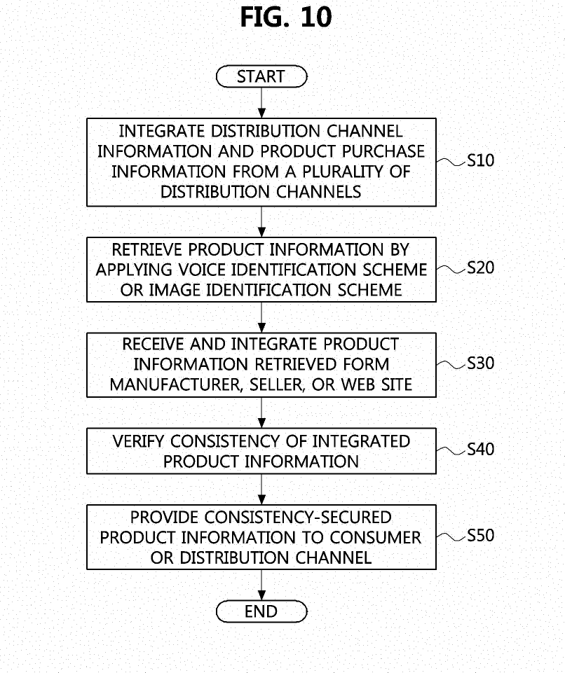

FIG. 10 is a diagram illustrating an omni-channel management method according to an embodiment of the present disclosure.

Referring to FIG. 10, a plurality of distribution channels may be managed through convergence of the plurality of distribution channels in order to implement an omni-channel centered on product information according to an embodiment of the present disclosure.

The distribution channel integration unit 112 may receive distribution channel information and product purchase information from each of the plurality of distribution channels such as offline stores, Internet shopping malls, digital signage, and mobile terminals, and integrate the received distribution channel information and product purchase information of each distribution channel (S10). The distribution channel integration unit 112 may provide the integrated distribution channel information and the product purchase information of each distribution channel to the product information verification unit 118.

Here, the plurality of distribution channels may logically mean different types of buyer contact channels. Also, the plurality of distribution channels may physically mean computer devices used for the buyer contact in the respective distribution channels. For example, a server that serves an online shopping mall, a POS apparatus located at an offline store, and a mobile shopping mall server that can be accessed through a mobile terminal may be applied as the plurality of distribution channels.

Then, the product identification integration unit 114 may retrieve information related to the product by applying the image identification technology and the voice identification technology (S20). The product identification integration unit 114 may integrate the retrieved information related to the product and provide the information to the product information verification unit 118. Specifically, the image identification technology may be applied to identify a product image or a barcode, a number, or a logo attached to the product to retrieve the information related to the product. Also, the voice identification technology may be applied to identify the information related to the product. For example, the product information such as a product name, a model number, a production site, and a delivery address maybe retrieved.

Then, the product information integration unit 116 may receive product information from a manufacturer, a seller, or a product information database (e.g., a web site) in order to provide the product information according to a product information request from a consumer or a distribution channel. Also, the product information integration unit 116 may receive the product information from the product identification integration unit 114. Then, the received product information may be integrated and transmitted to the product information verification unit 118 (S30). Here, as shown in FIG. 6, the product information may be generated in the form of metadata (e.g., the form of PIX).

The product information may include the product name (e.g., A ramen, B udon, C cosmetics, etc.). Also, the product information may include the EPC code or the EPC barcode shown in FIG. 7. Also, the product information may include the product image representing the appearance of the product. Specifically, a product representative image (e.g., a front image of the product), which best represents the product among images representing the appearance of the product, may be included in the product information. Also the product information may include an image descriptor that describes the characteristics of the product representative image (intrinsic properties distinguishing the representative image from other images as features or characteristics of the representative image). Also, the product information may include a 3D image of the product. Also, the product information may include a 313 image descriptor, which describes the characteristics of the 3D image of the product (intrinsic properties distinguishing the 3D image from other images as features or characteristics of the 3D image). Also, the product information may include a logo image or a logo video of the product or the manufacturer of the product. In addition, the product information may include a logo image descriptor or a logo video descriptor that describes information of the logo image or the logo video. Also, the product information may include a bar code image. In addition, the product information may include a bar code image descriptor, which describes the characteristics of the bar code image (intrinsic properties that distinguish it from other images as features or characteristics of the bar code image). Also, the product information may include a digital voice signal generated to represent the product name by voice. In addition, the product information may include a voice signal descriptor that describes the acoustic feature of the voice signal in the product information. Also, the product information may include information on related web sites providing information related to the product. Here, the related website information may be divided into directly-related web site information and indirectly-related web site information. The directly-related website information may include an Internet address of a home page of a company or store that produces, manages, and distributes the product or an Internet address of a home page providing information on the product, and the indirectly-related website information may include an Internet address of a home page providing information related to the product, or the website address of the vendor or store related to the product.

Then, the product information verification unit 118 may integrate primary product information collected by the logo identification scheme, the product image identification scheme, the barcode identification scheme, the voice identification scheme, and the EPC identification scheme, and verify whether the integrated details are correct for the same product. That is, it is verified that the plurality of detailed information is information on the same product so that the product information is consistent. In this manner, the product information verification unit 118 may verify whether the integrated product information is related to one product (S40).

Then, the product information whose consistency has been verified may be provided to the consumer and the distribution channel (S50). Here, the product information provided by the product information verification unit 118 may include the logo of the company that manufactured the product, the image of the product, the barcode of the product, the voice information of the product, and the EPC (product name, management number) of the product.

The consumer can check information on the distribution channels and the product information without restriction of time and space by using offline stores, internet shopping malls, digital signage, and mobile terminal. Also, it is possible to further confirm details of the product (price, refund policy, delivery information, location of the supply shop, etc.) based on the product information provided to the consumer. In the distribution channel, management of the distribution and manufacture of the product can be integrated and operated based on the received product information. This can enhance the automation of product distribution, production and management, reducing management and operating costs, and reducing time spent on business processes.

Using the apparatus and method for managing an omni-channel according to embodiments of the present disclosure, it is made possible to provide consistent product information useful for product purchase and management to consumers and distributors. In addition, by integrating distribution channels, product information, and product identification schemes, the omni-channel centered on consistent product information can be implemented.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An omni-channel management method comprising:
receiving a distribution channel information and a product purchase information from each of a plurality of distribution channels, and integrating the received distribution channel information and the product purchase information;
applying an image identification technology and a voice identification technology to retrieve and integrate information related to a product;
receiving and integrating product information from a manufacturer, a seller, or a web site;
verifying consistency of the integrated product information by checking whether detailed information included in the integrated product information is related to a same product; and
providing the consistency-secured product information to a consumer and a plurality of distribution channels.

2. The omni-channel management method according to claim 1, wherein the information related to the product is retrieved by identifying a barcode, a number, or a logo from an image of the product through the image identification technology.

3. The omni-channel management method according to claim 1, wherein the information related to the product is retrieved by identifying a product name, a model number, a production site, or a delivery site through the voice identification technology.

4. The omni-channel management method according to claim 1, wherein the product information is generated in a form of metadata, and includes at least one of a product name, an electronic product code (EPC), an EPC bar code, a bar code image, a bar code image descriptor, a product image, a product image descriptor, a product 3D image, a 3D image descriptor, a logo of the product or a company manufacturing the product, a logo image descriptor, a voice signal representing the product name, a voice signal descriptor, and information on a website providing information related to the product.

5. The omni-channel management method according to claim 4, wherein the information on a website includes a directly-related website information including an Internet address of a home page of a company or store that produces, manages, and distributes the product or an Internet address of a home page providing information on the product, and a indirectly-related website information including an Internet address of a home page providing information related to the product, or the website address of the vendor or store related to the product.

6. The omni-channel management method according to claim 1, wherein the product information is received and integrated through a logo identification scheme, a product image identification scheme, a bar code identification scheme, a voice identification scheme, and an EPC identification scheme, and it is verified whether the integrated product information is related to a same product.

7. An omni-channel management apparatus comprising:
a network interface connected to a plurality of distribution channels and a terminal of a consumer, which transfers a product purchase request and a production information request from the terminal;
a distribution channel integration unit receiving and integrating a distribution channel information and a product purchase information from each of the plurality of distribution channels;
a product identification integration unit retrieving information related to a product by applying an image identification technology and a voice identification technology, and integrating and outputting the retrieved information;
a product information integration unit receiving and integrating product information from a manufacturer, a seller, or a website; and
a product information verification unit verifying consistency of the integrated product information by checking whether detailed information included in the integrated product information is related to a same product, and outputting the consistency-secured product information.

8. The omni-channel management apparatus according to claim 7, wherein the network interface connects the plurality of distribution channels with the distribution channel integration unit, the product identification integration unit, the product information integration unit, and the product information verification unit, and provides the product purchase request and the production information request from the consumer to the plurality of distribution channels.

9. The omni-channel management apparatus according to claim 7, wherein the plurality of distribution channels include a server serving an online shopping mall, a Position of Sale (POS) apparatus disposed in an offline store, and a server serving a mobile shopping mall accessible through a mobile terminal, and the consistency-secured product information is provided to the plurality of distribution channels.

10. The omni-channel management apparatus according to claim 7, wherein the product identification integration unit retrieves the information related to the product by identifying a barcode, a number, or a logo from an image of the product through the image identification technology.

11. The omni-channel management apparatus according to claim 7, wherein the product identification integration unit retrieves the information related to the product by identifying a product name, a model number, a production site, or a delivery site through the voice identification technology.

12. The omni-channel management apparatus according to claim 7, wherein the product information integration unit generates the product information in a form of metadata, and the production information includes at least one of a product name, an electronic product code (EPC), an EPC bar code, a bar code image, a bar code image descriptor, a product image, a product image descriptor, a product 3D image, a 3D image descriptor, a logo of the product or a company manufacturing the product, a logo image descriptor, a voice signal representing the product name, a voice signal descriptor, and information on a website providing information related to the product.

13. The omni-channel management apparatus according to claim 7, wherein the product information verification unit integrates product information collected through a logo identification scheme, a product image identification scheme, a bar code identification scheme, a voice identification scheme, and an EPC identification scheme, and verifies whether the integrated product information is related to a same product.
